(19) United States
(12) Patent Application Publication
(10) Pub. No.: US 2011/0258577 A1
(43) Pub. Date: Oct. 20, 2011

(54) High Volume Scrollbar and Method for Using Same

(76) Inventors: Ryan Steelberg, Irvine, CA (US); Chad Steelberg, Newport Beach, CA (US)

(21) Appl. No.: 13/085,555

(22) Filed: Apr. 13, 2011

Related U.S. Application Data
(60) Provisional application No. 61/326,014, filed on Apr. 20, 2010.

(51) Int. Cl. G06F 3/048

(52) U.S. Cl. 715/786

(57) ABSTRACT

The present invention provides a system and method for navigate through large amounts of data in a quick and instantaneous manner by use of a scrollbar. The present invention may display information related to data being reviewed from a remote database, for example, without significantly increasing use of available processor capacity. The displayed information may allow the user of the present invention to effectively navigate large amounts of information.

### CROSS-REFERENCE TO RELATED APPLICATIONS

This application claims priority to United States Provisional Patent No. 61/326,014, entitled “A High Volume Scrollbar and Method for Using Same”, filed Apr. 20, 2010, which application is hereby incorporated by reference herein as if set forth in its entirety.

### FIELD OF THE INVENTION

The present invention is directed to navigation through a data set using a graphical user interface and, more particularly, to a high-volume scrollbar and method for using same.

### BACKGROUND OF THE INVENTION

Vast amounts of information can be present in computing devices and displayed by computer interfaces, such as computer displays. New user interfaces have thus become necessary for users to access and view the large volumes of information, in part because a computer display is finite and can only display a limited amount of information on screen at a given time. The amount of information on the screen at a given time is based on the size of the screen and the size of the information, including font size, to be displayed. When a large amount of information needs to be accessible to a user, and only a fraction of the information can be shown on the display at a single instance or if the user needs information that is not shown, access to this additional information must be provided for and this access includes a method of navigating through the information both displayed on screen and that hidden offscreen. One such interface allowing users to access information is a scrollbar. A scrollbar is a horizontal and/or vertical bar that contains a box that is clicked and dragged up, down, left, or right in order to scroll on a computer screen or to view data or information that is displayed in a format larger than that displayed on the screen. A scrollbar is a graphical object in a graphical user interface (GUI) with which texts, pictures or other information may be scrolled, such as the continuous movement of information either vertically or horizontally on a computer screen. A scroll bar may provide a means for allowing a user to select from a range of values. A scrollbar may indicate to a user that more information is available and may be accessed to display by movement of the scrollbar.

As a speed of computers and the amount of information contained thereon has increased, inefficiencies in the scrollbar have become evident. The inefficiencies in the scrollbar are magnified when data is stored remotely from the point from which it is accessed. Present scrollbars are ineffective at evidencing displayed information, downloaded information, and reserved or remotely accessible information, simultaneously. Further present scrollbar's lack the ability to efficiently handle larger volumes of information in a usable way.

Thus, there exists a need for and of all scrollbar that provides displayed information, downloaded information and reserved or remotely accessible information, simultaneously, while further efficiently handling large data volumes in a usable way.

### SUMMARY OF THE INVENTION

The present invention includes a scrollbar that may allow for a user to navigate through large amounts of data in a quick and instantaneous manner. The user, for example, may be reviewing data stored in a memory using a database application. The present invention may display information related to the data being navigated through without significantly increasing use of available processor capacity.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is an illustration of a scrollbar according to an aspect of the present invention;

FIG. 2 is a flowchart illustrating an exemplary method in accordance with the present invention;

FIG. 3 is an illustration of an embodiment of the present disclosure illustrating a scrollbar operating on a data set;

FIG. 4 is an illustration of an embodiment illustrating a scrollbar operating on a data set;

FIG. 5 is an illustration of an embodiment relating to a scrollbar of the present invention operating on a data set;

FIG. 6 is an illustration of an embodiment relating to a scrollbar of the present invention operating on a data set;

FIG. 7 is an illustration of an embodiment relating to a scrollbar of the present invention operating on a data set; and

FIG. 8 is an illustration of an embodiment of the scroll bar of the present invention operating on a smaller data set;

FIG. 9 is an illustration of an exemplary apparatus used with the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in graphical user interfaces. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

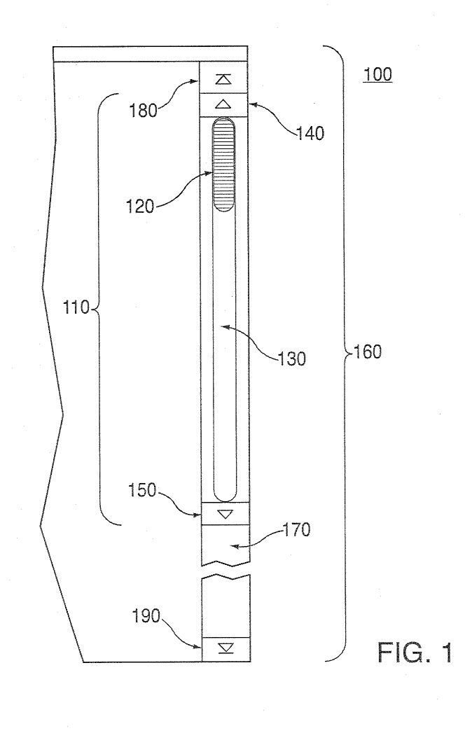

Referring now to FIG. 1, there is shown a scrollbar 100 according to an aspect of the present invention. Scrollbar 100 may include first scrollbar 110 within a second scrollbar 160. First scrollbar 110 may include a location monitor 120, a scroll box 130, a page up 140 and a page down 150. Second scrollbar 160 may include a larger scroll box 170, a fast up arrow 180 and a fast down arrow 190. Additionally, scrollbar 100 may include a zoom feature. Such a zoom feature may be included within scrollbar 110 and/or second scrollbar 160.

Scrollbars traditionally tend to be oriented horizontal or vertical, although any orientation may be used. Two scrollbars may act in tandem, such as having one vertical and one horizontal, or other orthogonal orientation, to allow movement through a data set in both axes. The scrollbar of the present invention may be used in tandem with another scrollbar, such as another of the type of the present invention or of the more traditional scrollbar to enable a user to move through a data set in two axes. The discussion herein is based primarily on a single scrollbar oriented in the vertical axis and the examples shown in the figures include a data set wherein the horizontal aspect of the data set fits on the screen at one time, thereby not requiring a scroll bar. It will be realized, that the scrollbar of the present invention may be used in either the horizontal or vertical or any other orientation and additionally may be used with other such scrollbars or more traditional scroll bar or user interface to provide movement through a data set.

First scrollbar 110 may be configured to include a location monitor 120 designed as a bullet type configuration operating within a scroll box 130 oriented as a pipe or tube allowing motion of location monitor 120 within scroll box 130 similar to a piston in a pipe. Page up 140 may be located at the top of the pipe created by scroll box 130 and page down 150 may be located at the bottom of scroll box 130.

Second scrollbar 160 may include a as a pipe larger scroll box 170. First scrollbar 110 may act as a location monitor for second scrollbar 160. In such a configuration, scrollbar 110 may be moved within larger scroll box 170. Fast up arrow 180 may be located above or adjacent to larger scroll box 170. Fast down arrow 190 may be located below or adjacent to larger scroll box 170.

Scrollbar 100 may be configured to generate and display a scrollbar to a user. Scrollbar 100 may be embodied as executable code that is resident in and executed by an electronic device, such as a computer, a computer display, a television, a mobile telephone, a PDA, and the like, for example. Scrollbar 100 may be a program stored on a computer or machine readable medium. Scrollbar 100 may be stand-alone software application or form a part of a software application that carries out additional tasks related to an electronic device.

While scrollbar 100 may operate on the data set as a whole, first scrollbar 110 may be designed or directed to operate on a subset of the available data or information that is being accessed. This subset may include a portion of the available data wherein the subset may be the data that is downloaded and accessed locally. The placement of first scrollbar 110 within second scrollbar 160 may be based on the portion of downloaded information represented by first scrollbar 110 as compared to the total information set represented by second scrollbar 160. For example, a total data set represented by second scrollbar 160 may include 100 items, and when items 40-60 were downloaded and represented by first scrollbar 110, first scrollbar 110 may be located exactly in the middle of second scrollbar 160, that is starting at the 40% point of larger scroll box 170 and extending down to the 60% point of larger scroll box 170 within second scrollbar 160.

Location monitor 120 may be sized to evidence the information displayed on the screen. The placement of location monitor 120 within scroll box 130 may be based on the information displayed on the screen as compared to the information set that is downloaded. For example, if 10 items are downloaded, and 3 items are displayed, such as items 3, 4, 5 of the information set, then location monitor 120 may be approximately ⅓ of the size of scroll box 130 and may be located from approximately 20% down in scroll box 130 to the midpoint of scroll box 130, for example. The size of location monitor 120 may indicate the data that is being displayed on the screen. For example, the ratio of the size of the display area to the size of the displayed data set and the position of location monitor 130 along the scrollbar 110 indicates the location of the display area which is being displayed.

Scroll box 130 may represent the downloaded data that is available for display. Scroll box 130 may house location monitor 120. As location monitor 120 represents the displayed data on the screen, scroll box 130 represents the downloaded data, for example, and provides a framework in which to move location monitor 120 to display different portions of the downloaded portion of the data set. Scroll box 130 may take the form of a hollow tube that allows location monitor 120 to be a bullet moved within the hollow tube, such as acting as a piston within a valve, for example.

Page up 140 may take the form of a clickable box that may contain an upward triangle to indicate direction of operation, for example. Actuating the box of page up 140 may move location monitor 120 up within scroll box 130 by a single line, a group of lines, a page or other actuatable distance.

Alternatively, page up 140 may be used to effectuate movement of first scrollbar 110 within larger scroll box 170, for example. In such configuration, actuation of page up 140 may move first scrollbar 110 up within larger scroll box 170 by exactly one page of displayed information. One page is displayed information may be one page of viewable data on the screen or may take the form of one page of downloaded data some of which may be viewable on the screen.

Page down 150 may similarly operate as page up 140. Page down 150 may take the form of a clickable box that may contain a downward triangle, for example. Actuating a box of page down 150 may move location monitor 120 down within scroll box 130 by single line, a group of lines, a page or other actuatable distance.

Alternatively page down 150 may be used to effectuate movement of first scrollbar 110 within larger scroll box 170, for example. According to an aspect of the present invention, actuation of page down 150 may move for scrollbar 110 down within larger scroll box 170 by exactly one page of displayed information.

Second scrollbar 160 may be designed to operate on the data set as a whole. Second scrollbar 160 may be configured to utilize first scrollbar 110 as the location monitor for second scrollbar 160 and corresponding larger scroll box 170. The placement of first scrollbar 110 within second scrollbar 160 may be based on the portion of downloaded information represented by first scrollbar 110 as compared to the total information set represented by second scrollbar 160. As set forth hereinabove, in the case where a data set includes 100 items, a total data set represented by second scrollbar 160, and when items 40-60 were downloaded and represented by first scrollbar 110, first scrollbar 110 operating as the location monitor of second scroll bar 160 may be located exactly in the middle of larger scroll box 170 of second scrollbar 160.

Larger scroll box 170 may operate within second scrollbar 160 using first scrollbar 110 as a location monitor. Larger scroll box 170 operate similarly to scroll box 130 and its associated location monitor 120. Larger scroll box 170 may operate to evidence all available data in the data set. The movement of first scrollbar 110, operating as a location monitor for larger scroll box 170, selects portions of the entire data set to be included within viewable display. Actuating first scrollbar 110 may cause tags to appear on the screen adjacent to scrollbar 100 to provide guidance to a user regarding the actuation.

Fast up arrow 180 may be configured as an arrow plus an additional line to distinguish from page up 140. Fast up arrow 180 may be configured to expedite on screen display to the top of the data list, for example.

Fast down arrow 190 may be configured as an arrow plus an additional line to distinguish from page down 150. Fast down arrow 190 may be configured to expedite on screen display to the bottom of the data list, for example.

When a location monitor, such as location monitor 120 or first scroll bar 110 operating as a location monitor for second scrollbar 160, completely fills a scroll box, such as scroll box 130 or larger scroll box 170, this indicates that the entire data set is being viewed, at which point the scrollbar may temporarily become hidden. For example, in the case where first scrollbar 110 completely fills larger scroll box 170, this may be a indication that the entirety of the data set has been downloaded, and may further indicate that the data set may be manageable using only first scroll bar 110. In the case where location monitor 120 completely fills scroll box 130, this may be an indication that all downloaded or locally available data is being displayed within the viewing area for the user. When both of these occurrences are simultaneously fulfilled, this indicates that all of the data in the data set is being viewed on the screen. In this situation, it may cause scrollbar 100 to disappear.

According to an exemplary embodiment, the scrollbar of the present invention may used on data that is being populated, such as data that is being downloaded, for example. In such an embodiment, while making the downloading data set available to the user, there may be a benefit in showing the useable available data, and updating the display as updates and downloaded data are received. This has the advantage of permitting the user to work with the data while data continues to download. This is important because some data sets may be very large and take considerable time to download. In this situation the size of first scrollbar 110 decreases as new data is downloaded to reflect the new ratio of visible items to available items, and also if the first scrollbar 110 is not at the top of larger scroll box 170, first scrollbar 110 may also move upwards as the relative location of the visible data changes, such as for example when the continuously downloaded or later downloaded data occurs at the end of the data set, for example.

For example, if initially the data set is composed of 10 items and three of those are displayed, the size of first scrollbar 110 may be approximately ⅓ the size of larger scroll box 170. If an additional 10 items are downloaded into the data set represented by larger scroll box 170, thereby making the data set 20 items, first scrollbar 110 may decrease in size to approximately ⅙ the size of larger scroll box 170—½ half of the previous size. In a situation where the additional 10 items reside at the end of the data set for scrollbar 110 may remain at the top of larger scroll box 170. If the first scrollbar 110 was previously located at the bottom of larger scroll box 170, and the additional data reside at the end of the data set, first scroll bar 110 may, in addition to resizing, reposition to be in the middle of larger scroll box 170.

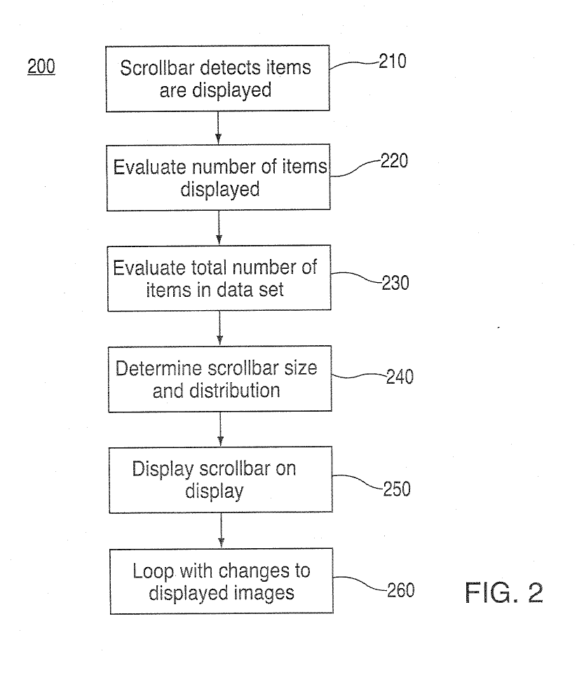

Referring now to FIG. 2, there is shown a flowchart illustrating an exemplary method 200 in accordance with the present invention. Method 200 includes step 210, where scrollbar detects whether an item or items such as data is displayed on the display. This may occur, for example, when a user is reviewing data stored in a memory using a database application. As discussed herein above, the displayed items and data may correspond to merely a portion of the full data set or listing of items, some of which will not be displayed. At step 220, the number of items displayed is evaluated, at step 230 the total number of items in the information set is evaluated. After the number of items displayed and the total number of items are evaluated, the scrollbar size and distribution may be determined at step 240. Such a determination may be made by analyzing the displayed images with reference to the total images in the array to determine a suitable scroll bar size and distribution. This size and distribution may be based on the ratio of the displayed items to the number of total items. At step 250, the scrollbar may be displayed on the display with the corresponding location of the displayed images highlighted. Once the scrollbar is displayed, the highlighted location may be continually updated such that it corresponds with the currently displayed items as a user scrolls through the array of items. At step 260, if the location of the displayed images changes, the method reverts back to step 250, and the scrollbar updates such as the new location is evidenced.

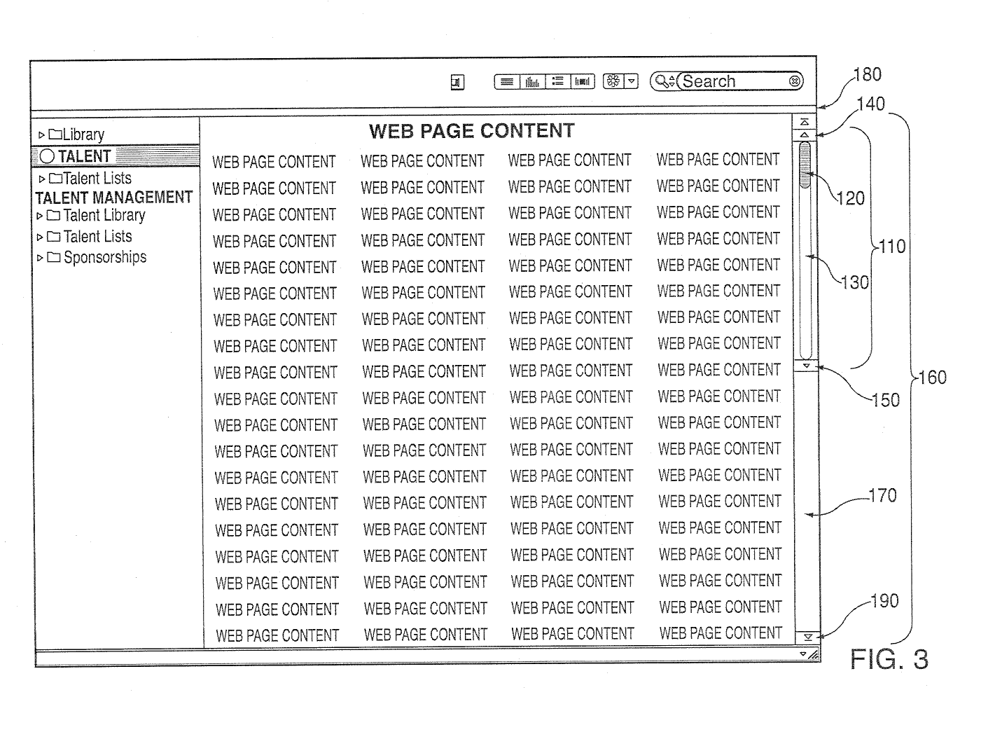

Referring now to FIG. 3, there shown an embodiment of the present disclosure illustrating scrollbar 100 operating on a data set. In this depiction, scrollbar 110 is shown at the top of the data set. This may occur by either actuating fast up arrow 180 or by using page up arrow 140 until the top of the data set was reached. The top of the data set is being viewed as depicted by the relationship of first scroll bar 110 within second scroll bar 160 and location monitor 120 associated at the top of scroll box 130.

FIG. 3 illustrates scroll bar 100 providing operation on a data set. This depiction represents a data set wherein the on-screen data display is approximately one third of the data displayed, as shown by the relationship of the size of location monitor 120 to scroll box 130. The data displayed in this depiction is approximately one-half of the available data as shown by the relationship between first scroll bar 110 and larger scroll box 170.

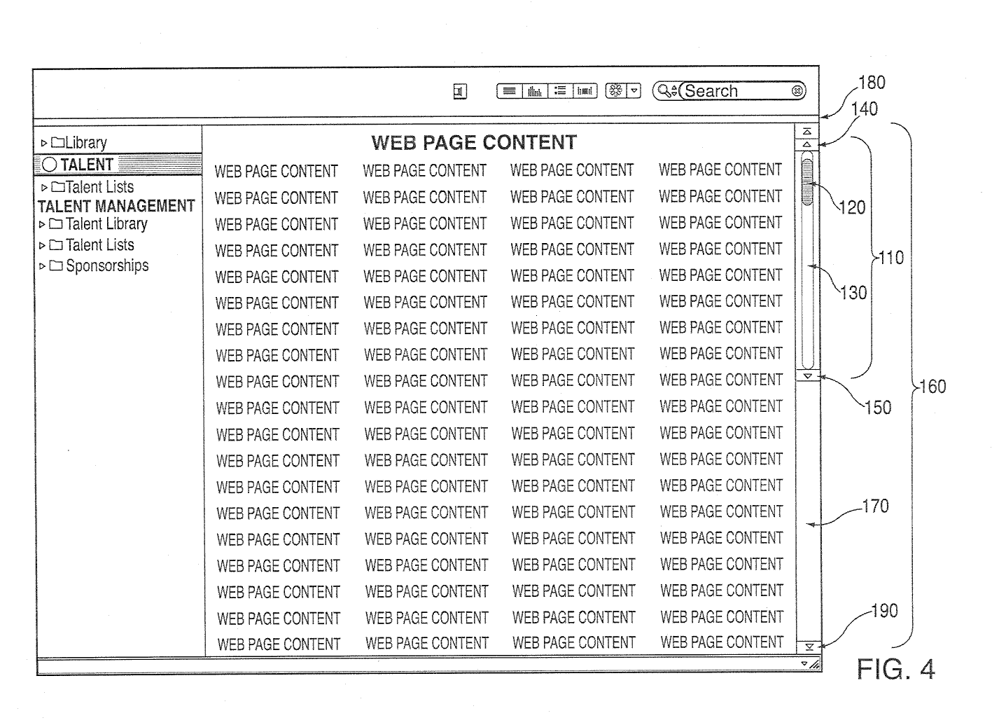

Referring now to FIG. 4, there is shown the embodiment of FIG. 3 of the present disclosure illustrating scrollbar 100 operating on a data set. As is depicted in FIG. 4, first scroll bar 110 may be activated to view portions of the displayed data by display on the screen. Displayed data may be selected for display onto the screen using location monitor 120 and its position within scroll box 130. Scroll box 130 represents the displayed data and location monitor 120 represents that portion of the displayed data displayed on-screen, As illustrated in FIG. 4, the displayed data is the top half of the data set, as described similarly with respect to FIG. 3 above. This is represented by first scrollbar approximately ½ the size of larger scroll box 170. First scroll bar 110 is movable to select the portion of the data set that represents the displayed data set within larger scroll box 170. As described with respect to FIG. 3, the on-screen data represents being approximately one-third of displayed data. This is represented by location monitor 120 being approximately ⅓ the size of scroll box 130. Location monitor 120 is movable to select the portion of the displayed data for display on the screen within scroll box 130.

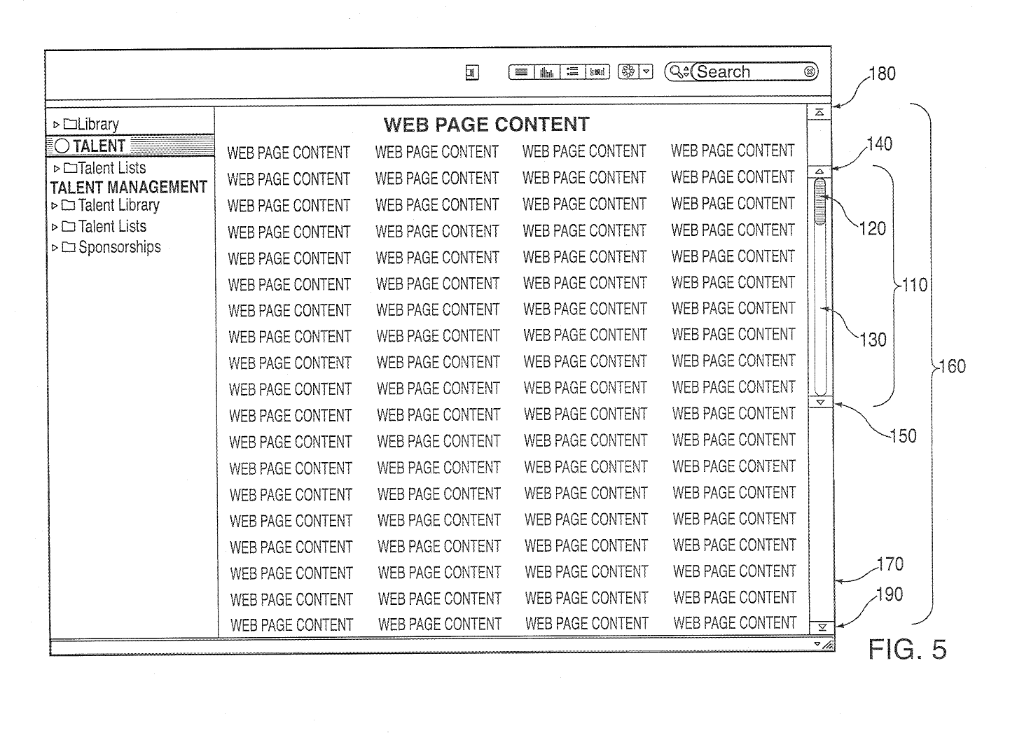

Referring now to FIG. 5, there shown an embodiment as described herein above relating to scrollbar 100 operating on a data set. As illustrated in FIG. 5, first scrollbar 110 may be activated within larger scroll box 170 causing a portion of the data set to become the displayed portion and to display on the screen a different portion of the data set. Location monitor 120 may be activated at the top of scroll box 132 to display on-screen the top portion of the displayed portion of the data set. In FIG. 5, first scrollbar 110 may be actuated downward within larger scroll box 170 causing the displayed portion of the data set to be a lower portion than that previously displayed. For example, scrollbar 110 may be actuated approximately 20% down from the top and therefore has selected as the displayed portion of the data set approximately the 20% to the 60% point as compared to that in FIG. 4 and described above wherein the displayed portion of the data set was approximately the top 50% of the data set, such as from 0-50%, for example.

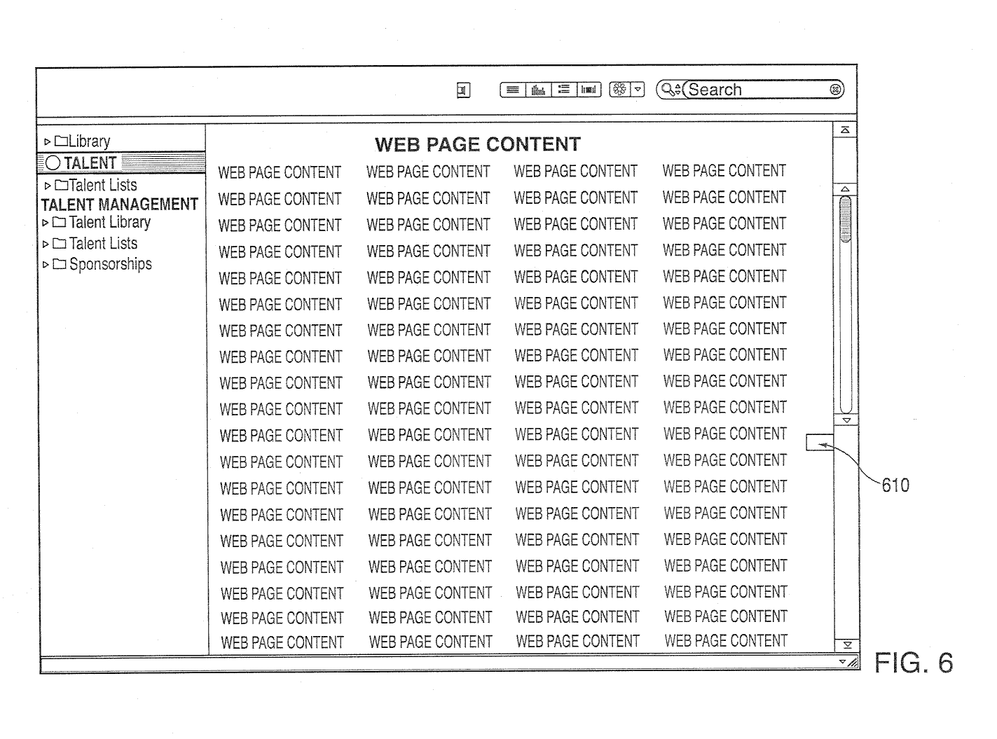

Referring now to FIG. 6, there is shown a scrollbar operating on a data set according to the present invention. Similar to the scrollbar shown in FIG. 5, first scrollbar 110 may be actuated within larger scroll box 170 to select a display of the data set from approximately the 20% to 60% point. Additionally shown in FIG. 6, there is shown a location index 610 displayed as “CO” designating a point where placement of first scroll bar 110 operating as the location monitor of second scrollbar 160 may be placed to provide data from the data set correspondent to “CO.” Such a location index 610 may be configured to appear upon a user interaction that moves first scroll bar 110 as a location monitor within second scroll bar 160. The movement of first scrollbar 110 within larger scroll box 170 may utilize location index 610 to indicate the positioning of first scrollbar 110 upon actuation to select a different displayed portion of the data set. Location index 610 may be viewable by selecting, for example, scrollbar 110 as a movable location monitor within larger second scrollbar 160 as the location monitor is being actuated within larger scroll box 170, for example. As shown as first scrollbar 110 is actuated downward in larger scroll box 170, location index 610 may appear to enable user to visualize a pointer indicating the portion of the data set that is being selected by the actuation that is occurring.

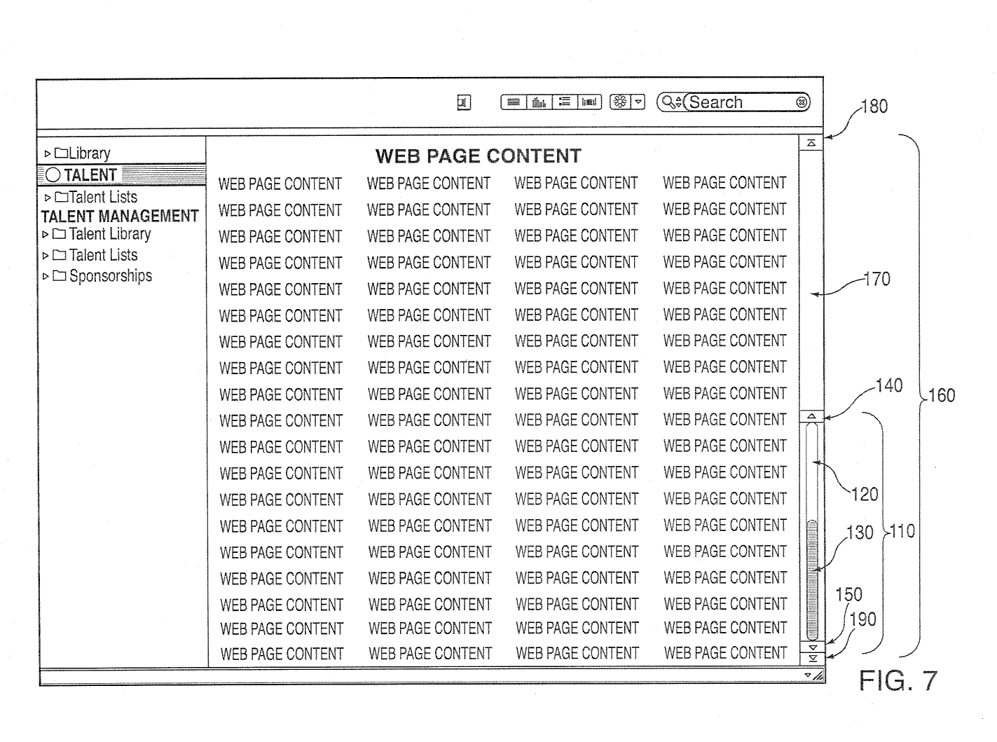

Referring now to FIG. 7, there shown the scrollbar of the present invention acting on a data set. As is illustrated in FIG. 7, upon actuation of a fast down arrow 190, first scrollbar 110 may actuate to the bottom of the data set. Fast down arrow 190 may also, either in addition to actuating first scroll bar 110 to the bottom of the data set, or in lieu of such actuation, cause the location monitor 120 to be actuated to the bottom of scroll box 130. Fast down arrow 190 may be designed to not actuate location monitor 120 to the bottom of scroll box 130, but may instead location monitor 120 may remain at the top of scroll box 130. As shown fast down arrow 190 may activate location monitor 120 to display the bottommost portion of the data set and further to display the bottom portion of the displayed data set on the screen.

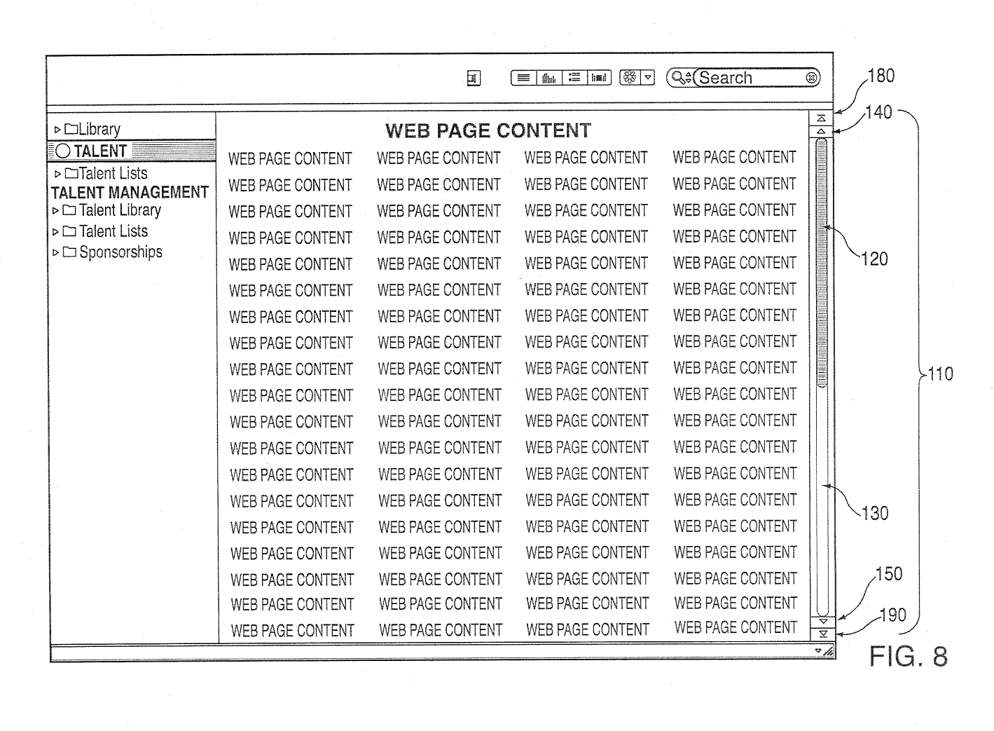

Referring now to FIG. 8, there is shown an embodiment of the present disclosure illustrating scrollbar 100 operating on a smaller data set. As is illustrated in FIG. 8, first scrollbar 110 has expanded correspondent to the size of the underlying dataset that is being displayed, as described herein. Because this underlying dataset is smaller than those data sets previously described, first scrollbar 110 has expanded to completely fill larger scrollbox 170. In this example, the overall scrollbar 100 as depicted includes location monitor 120, scroll box 130, page up arrow 140, page down arrow 150, fast up arrow 180, and fast down arrow 190. Generally, page up arrow 140, page down arrow 150, fast up arrow 180, and fast down arrow 190 remain as depicted and discussed hereinabove. First scrollbar 110 has expanded correspondent to the size of the underlying data set and completely fills larger scroll box 170, which is completely covered thereby. Location monitor 120 may be larger than that depicted hereinabove illustrating that the data displayed in the visible portion of the screen is approximately half of the data set that is available for display. Location monitor 120 and the displayed portion of scroll box 130 are therefore approximately the same size. Second scrollbar 160 does not exist in this depiction because the data set is of a manageable size. This enables page up arrow 140 and fast up arrow 180 to be adjacent to each other and similarly page down arrow 150 and fast down arrow 190. As shown, location monitor 120 depicts that the upper half of the data set is being displayed on the display screen, and scroll box 130 shows other portions of the data set available for display.

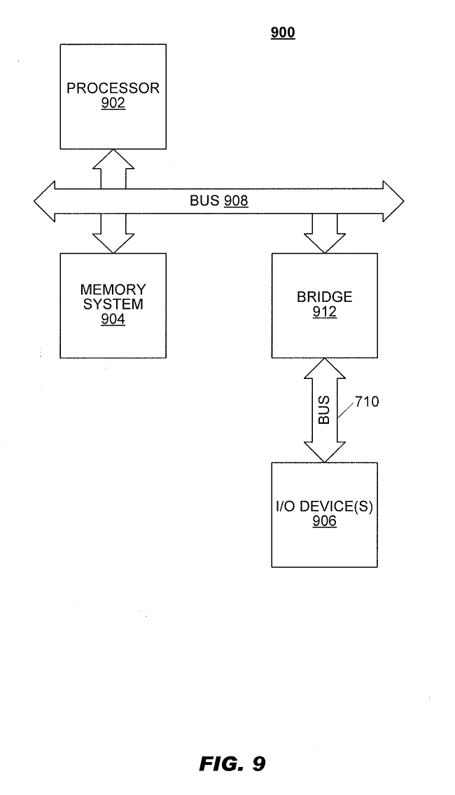

FIG. 9 is an example of a simplified functional block diagram of a computer system 900. The functional descriptions of the present invention can be implemented in hardware, software or some combination thereof. For example, a recommendation engine and an integration engine of the present invention can be implemented using a computer system.

As shown in FIG. 9, the computer system 900 includes a processor 902, a memory system 904 and one or more input/output (I/O) devices 906 in communication by a communication ‘fabric’. The communication fabric can be implemented in a variety of ways and may include one or more computer buses 908, 910 and/or bridge and/or router devices 912 as shown in FIG. 9. The I/O devices 906 can include network adapters and/or mass storage devices from which the computer system 900 can send and receive data for generating and transmitting advertisements with endorsements and associated news. The computer system 900 may be in communication with the Internet via the I/O devices 908.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

1. A user interface control for scrolling and selecting data for display, said control comprising:
a scrollbar including a location monitor located within a scroll box, said location monitor comprising:
a displayed scroll box housing a display location monitor;
a page up arrow; and
a page down arrow;
a fast up arrow; and
a fast down arrow.

2. The user interface of claim 1, wherein said scroll box corresponds to the data for display.

3. The user interface of claim 1, wherein said displayed scroll box corresponds to the portion of the data that is available for viewing.

4. The user interface of claim 1, wherein said displayed location monitor corresponds to the data displayed on a user display.

5. The user interface of claim 1, wherein said page up arrow actuates said displayed location monitor up within said displayed scroll box to select the portion of the data that is displayed.

6. The user interface of claim 1, wherein said page down arrow actuates said displayed location monitor down with said displayed scroll box to select the portion of the data that is displayed.

7. The user interface of claims 5 and 6, wherein said actuation moves by one of a single line of data, a group of lines of data, and a full displayed page of data.

8. The user interface of claim 1, wherein said page up arrow actuates said location monitor up within said scroll box to select the portion of the data that is available for display.

9. The user interface of claim 1, wherein said page down arrow actuates said displayed location monitor down with said displayed scroll box to select the portion of the data that is available for display.

10. The user interface of claims 8 and 9, wherein said actuation moves by one page of data available for display.

11. The user interface of claim 1, wherein said fast up arrow expedites the movement of the displayed data to the top of the data set.

12. The user interface of claim 1, wherein said fast down arrow expedites the movement of the displayed data to the bottom of the data set.

13. A method of providing a user interface, said method comprising:
detecting whether a plurality of items is displayed on the display, wherein said plurality of items is a portion of a data set;
evaluating the number of said plurality of items displayed;
determining the total number of said plurality of items in the data set;
identifying a scrollbar size and distribution from said evaluating and said determining;
displaying said identified scrollbar with features correspondent to the displayed plurality of items; and
if the correspondence of the displayed plurality to items changes location of the displayed images changes re-displaying said identified scrollbar with features correspondent to the displayed plurality of items.

14. The method of claim 13, wherein said features comprise a location monitor.

15. The method of claim 13, wherein said features comprise a scroll box.

16. The method of claim 13, wherein said features comprise first scroll bar formed from a location monitor and a scroll box.

17. The method of claim 13, wherein said features further comprise a second scroll bar formed with said first scroll bar as the location monitor and a second scroll box.

18. The method of claim 13, wherein said plurality of items comprise data.

19. The method of claim 13, wherein said size and distribution are correspondent on the ratio of the displayed plurality of items to the total number of said plurality of items in the data set.
